(19) United States
(12) Patent Application Publication
(10) Pub. No.: US 2025/0316684 A1
(43) Pub. Date: Oct. 9, 2025

(54) BLENDED LITHIUM AND MANGANESE-RICH (LMR) BATTERY CELLS

(71) Applicant: GM Global Technology Operations LLC, Detroit, MI (US)

(72) Inventors: Gongshin Qi, Troy, MI (US); Lei Wang, Rochester Hills, MI (US); Raneen Taha, Sterling Heights, MI (US); Mingjie Tu, Sterling Heights, MI (US); Yangbing Zeng, Troy, MI (US); Han Zhang, Shelby Township, MI (US)

(21) Appl. No.: 18/626,964

(22) Filed: Apr. 4, 2024

(51) Int. Cl. H01M 4/36; H01M 4/02; H01M 4/131; H01M 4/58

(52) U.S. Cl. CPC H01M 4/366; H01M 4/131; H01M 4/5825; H01M 2004/021; H01M 2004/028; H01M 2220/20

(57) ABSTRACT

A battery cell, a battery including a battery cell, and a vehicle including a battery. The battery cell includes a cathode including a lithium and manganese rich composition and a lithium iron phosphate composition, a cathode current collector connected to the cathode, an anode, an anode current collector connected to the anode, a separator positioned between the cathode and anode, and an electrolyte contacting the anode and the cathode.

### BACKGROUND

Electric and hybrid electric vehicle technology is enabled by the development and deployment of rechargeable, secondary batteries, which provide energy to the vehicle powertrain. Secondary batteries include lithium ion batteries, which generally include a cathode, anode, separator, and electrolyte. The cathode provides the source of lithium ions and determines the capacity and average voltage of a battery. Various lithium cathode chemistries have been introduced and often include transition metals such as iron or manganese. Examples of lithium cathode chemistries include lithium iron phosphate (LFP), lithium ion manganese oxide (LMO), lithium nickel manganese oxide (LNMO), lithium and manganese rich (LMR), and lithium ferro manganese phosphate (LFMP). The anode stores and releases lithium ions received from the cathode when energy is needed, the separator prevents the cathode and anode from contacting and shorting out the battery, and the electrolyte provides a medium between the cathode and anode through which the lithium ions travel.

Each of the various cathode chemistries perform different and exhibit different properties. Such properties include direct current internal resistance, heat generation, specific capacity, and capacity retention. Some chemistries, for example, exhibit more favorable direct current internal resistance and heat generation characteristics at various states of charge yet exhibit lower discharge specific capacities, or vice versa. A given cathode chemistry is selected based on these properties, among others, depending on application. While the secondary lithium-ion cathode chemistries generally achieve their intended purpose; there remains a need for new and improved secondary lithium-ion cathode chemistries for use in electric and hybrid-electric vehicles.

Thus, while present lithium cathode chemistries achieve their intended purpose, there is a need for new and improved cathode chemistries that offer reduced heat generation and internal resistance at various states of charge while maintaining discharge specific capacities.

### SUMMARY

According to various aspects, the present disclosure is directed to a battery cell for a vehicle. The battery cell includes a cathode including a lithium and manganese rich composition and a lithium iron phosphate composition, a cathode current collector connected to the cathode, an anode, an anode current collector connected to the anode, a separator positioned between the anode and cathode, and an electrolyte contacting the anode and the cathode. The lithium and manganese rich composition exhibits the following formula: xLi₂MnO₃*(1−x)LiMO₂, wherein x is in the range of 0.1 to 1, M is at least one of manganese, cobalt, and nickel, and the lithium and manganese rich composition is present in a range of 1 weight percent to 99 weight percent of the total weight of the cathode. The lithium iron phosphate composition exhibits the following formula: (LiMn₍ₓ₎Fe₍₁₋ₓ₎PO₄), wherein x is in the range of 0 and 0.95, and the lithium iron phosphate composition is present in the range of 1 weight percent to 99 weight percent of the total weight of the cathode.

In embodiments of the above, the lithium and manganese rich composition is present in a range of 75 weight percent to 85 weight percent of the total weight of the cathode and the lithium iron phosphate composition is present in the range of 15 weight percent to 25 weight percent of the total weight of the cathode.

In any of the above embodiments, the cathode includes a first layer of the lithium and manganese rich composition contacting the cathode current collector and a second layer of the lithium iron phosphate composition contacting the electrolyte. In further embodiments, the total thickness of the cathode is 50 micrometers to 200 micrometers and the thickness of the first layer of the lithium and manganese rich composition is in the range of 50 percent to 95 percent of the total thickness of the cathode and the thickness of the second layer of the lithium iron phosphate composition is in the range of 5 percent to 50 percent of the total thickness of the cathode. In yet further embodiments, at least one additional of layer of the lithium and manganese rich composition and at least one additional layer of the lithium iron phosphate composition are alternately layered between the first layer of the lithium and manganese rich composition and the second layer of the lithium iron phosphate composition. Alternatively, the cathode includes domains of lithium and manganese rich composition mixed with domains the lithium iron phosphate composition, wherein the domains of the lithium and manganese rich composition exhibits a length in the range of 5 micrometers to 15 micrometers and the domains of the lithium iron phosphate composition exhibit a length in the range of 1 micrometer to 10 micrometers.

In any of the above embodiments, the anode includes at least one or more of the following materials: graphite, silicon, silicon oxide, and lithium metal.

In any of the above embodiments, the electrolyte includes a lithium salt dissolved in a non-aqueous organic solvent.

In any of the above embodiments, a ratio of the anode capacity to cathode capacity (N/P ratio) is in the range of 1 to 1.3.

According to various additional aspects, the present disclosure relates to a secondary battery for a vehicle. The secondary battery includes a plurality of battery cells. Each battery cell includes a cathode including a lithium and manganese rich composition and a lithium iron phosphate composition, a cathode current collector connected to the cathode, wherein the cathode current collectors of each of the plurality of battery cells are connected together, an anode, an anode current collector connected to the anode, wherein the anode current collectors of each of the plurality of battery cells are connected together, a separator positioned between the anode and the cathode, and an electrolyte contacting the anode and the cathode. The lithium and manganese rich composition exhibits the following formula: xLi₂MnO₃*(1−x)LiMO₂, wherein x is in the range of 0.1 to 1, M is at least one of manganese, cobalt, and nickel, and the lithium and manganese rich composition is present in a range of 1 weight percent to 99 weight percent of the total weight of the cathode. The lithium iron phosphate composition exhibits the following formula: (LiMn₍ₓ₎Fe₍₁₋ₓ₎PO₄), wherein x is in the range of 0 and 0.95, and the lithium iron phosphate composition is present in the range of 1 weight percent to 99 weight percent of the total weight of the cathode.

In embodiments of the above, the lithium and manganese rich composition is present in a range of 75 weight percent to 85 weight percent of the total weight of the cathode and the lithium iron phosphate composition is present in the range of 15 weight percent to 25 weight percent of the total weight of the cathode.

In any of the above embodiments, the cathode includes a first layer of the lithium and manganese rich composition contacts the cathode current collector and a second layer of the lithium iron phosphate composition contacts the electrolyte. In further embodiments, the total thickness of the cathode is 50 micrometers to 200 micrometers and the thickness of the first layer of the lithium and manganese rich composition is in the range of 50 percent to 95 percent of the total thickness of the cathode and the thickness of the second layer of the lithium iron phosphate composition is in the range of 5 percent to 50 percent of the total thickness of the cathode. In yet further embodiments, at least one additional of layer of the lithium and manganese rich composition and at least one additional layer of the lithium iron phosphate composition are alternately layered between the first layer of the lithium and manganese rich composition and the second layer of the lithium iron phosphate composition. Alternatively, the cathode includes domains of lithium and manganese rich composition mixed with domains the lithium iron phosphate composition, wherein the domains of the lithium and manganese rich composition exhibits a length in the range of 5 micrometers to 15 micrometers and the domains of the lithium iron phosphate composition exhibit a length in the range of 1 micrometer to 10 micrometers.

In any of the above embodiments, the anode comprises at least one or more of the following materials: graphite, silicon, silicon oxide, and lithium metal.

In any of the above embodiments, the electrolyte includes a lithium salt dissolved in a non-aqueous organic solvent.

In any of the above embodiments, the cathode, the cathode current collector, the anode, the anode current collector, and the separator are in the form of a roll forming a cylinder, the cathode current collector is connected to a first tab and the anode current collector is connected to a second tab. Alternatively, each battery cell further includes a pouch defining a volume, wherein the cathode, the cathode current collector, the anode, the anode current collector, and the separator are positioned at least partially in the volume defined by the pouch.

According to various additional aspects, the present disclosure is directed to a vehicle. The vehicle includes a powertrain, the powertrain including a battery. The battery includes a plurality of battery cells and each battery cell includes: a cathode including a lithium and manganese rich composition and a lithium iron phosphate composition, a cathode current collector connected to the cathode, an anode, an anode current collector connected to the anode, a separator positioned between the anode and the cathode, and an electrolyte contacting the anode and the cathode. The lithium and manganese rich composition exhibits the following formula: xLi₂MnO₃*(1−x)LiMO₂, wherein x is in the range of 0.1 to 1, M is at least one of manganese, cobalt, and nickel, and the lithium and manganese rich composition is present in a range of 1 weight percent to 99 weight percent of the total weight of the cathode. The lithium iron phosphate composition exhibits the following formula: (LiMn₍ₓ₎Fe₍₁₋ₓ₎PO₄), wherein x is in the range of 0 and 0.95, and the lithium iron phosphate composition is present in the range of 1 weight percent to 99 weight percent of the total weight of the cathode.

### BRIEF DESCRIPTION OF DRAWINGS

The drawings described herein are for illustration purposes only and are not intended to limit the scope of the present disclosure in any way.

FIG. 1 illustrates a vehicle and a power train including a secondary battery according to embodiments of the present disclosure.

FIG. 2A illustrates a battery according to embodiments of the present disclosure.

FIG. 2B illustrates a pouch or prismatic battery cell according to embodiments of the present disclosure.

FIG. 2C illustrates a cylindrical battery cell according to embodiment of the present disclosure.

FIG. 3 illustrates a cathode disposed on a cathode current collector, the cathode including a blend of a lithium and manganese rich composition and a lithium iron phosphate composition according to embodiments of the present disclosure.

FIG. 4 illustrates a cathode including a lithium and manganese rich composition coated with a lithium iron phosphate composition according to embodiments of the present disclosure.

FIG. 5 illustrates a cathode disposed on a cathode current collector, the cathode including a layer of a lithium and manganese rich composition contacting the cathode current collector and layer a lithium iron phosphate composition disposed on the lithium and manganese rich composition according to embodiments of the present disclosure.

FIG. 6 illustrates a graph of the resistance as measured relative to the state of charge according to an embodiment of the present disclosure. The horizontal axis (x-axis) is the percentage of the state of charge (SOC) and the vertical axis (y-axis) is the resistance (Ohm).

FIG. 7 illustrates a graph of specific capacity and retention measured relative to cycle number of a battery according to an embodiment of the present disclosure. The horizontal axis (x-axis) is the cycle number, the primary vertical axis (y-axis) on the left is the Specific Heat Capacity (mAh/g) and the secondary vertical axis (y-axis) on the right is the retention percentage).

FIG. 8 illustrates the direct current internal resistance relative to state of charge for a battery according to an embodiment of the present disclosure compared to a battery including a cathode composed only of a lithium and manganese rich composition. The horizontal axis (x-axis) is the range of State of Charge (SOC) and the vertical axis (y-axis) is the DCIR Continuous (Ohm).

FIG. 9 illustrates the heat generation relative to state of charge for a battery according to an embodiment of the present disclosure compared to a battery including a cathode composed only of a lithium and manganese rich composition. The horizontal axis (x-axis) is the ranges of State of Charge (SOC) and the vertical axis (y-axis) is the Heat Generation (W).

FIG. 10 illustrates specific discharge capacity relative to the operating voltage window for a battery according to an embodiment of the present disclosure compared to a battery including a cathode composed only of a lithium and manganese rich composition. The horizontal axis (x-axis) is the Voltage (V) and the vertical axis (y-axis) is the Specific Discharge Capacity (mAh/g).

FIG. 11 illustrates voltage relative to specific capacity of a battery according to an embodiment of the present disclosure. The horizontal axis (x-axis) is the specific capacity (mAh/g) and the vertical axis (y-axis) is the Voltage (V).

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale.

The present disclosure is related to a cathode including domains or layers of a lithium and manganese rich composition and a lithium iron phosphate composition. The cathodes are incorporated into battery cells and secondary batteries. The batteries may then be used in electric or hybrid-electric vehicles including batteries using battery cells employing the cathode compositions. The present disclosure further relates to a methods of forming the cathodes and battery cells.

As used herein, the term “vehicle” is not limited to automobiles. While the present technology is described primarily herein in connection with electric and hybrid-electric vehicles, the technology is not limited to electric and hybrid-electric vehicles. The concepts can be used in a wide variety of applications, such as in connection with components used in motorcycles, mopeds, locomotives, aircraft, marine craft, and other vehicles, as well as in other applications utilizing batteries, such as in portable power stations, such as those used for powering remote job sites, emergency back-up power supplies, and permanent power stations associated with buildings and equipment, all of which may be powered by, for example, solar or wind-powered generator systems, power mains, and fuel based power generators such as gasoline, propane, kerosene, or diesel generators as well as sterling engines.

FIG. 1 illustrates a vehicle 100 including a propulsion system 120. The propulsion system 120 generally includes an electric motor 124 and a secondary battery 126 for powering the electric motor 124. Further, in many embodiments of the propulsion system 120, the propulsion system 120 includes an inverter 128 for changing power from DC (direct current) as provided by the battery 126 to AC (alternating current) as it is used by the electric motor 124. The inverter 128 may be included in a power electronics module 130, which includes e.g., transistors and diodes, for switching the power from DC to AC and vice-versa.

A controller 132 is connected to the inverter 128 and is programmed to control and manage the operations of the electric motor 124 and associated hardware, including the inverter 128. The electric motor 124 is connected to a transmission (drive unit) 136, and drive line 138, which transfers mechanical power and rotation to the wheels 140 of the vehicle 100. The controller 132 includes one or more one or more processors and tangible, non-transitory memory 134.

With reference again to the electric motor 124, the electric motor 124, powered by the battery 126, includes a stator 142 and a rotor 144 arranged with the stator 142. The stator 142 is the stationary part of the electric motor 124. The stator 142 provides a rotating magnetic field with which the stationary magnetic field of the rotor 144 tries to align with, causing the rotor 144 to rotate, in what may be referred to as “motoring” mode. In other applications the rotor's 144 rotating field (as caused by physical rotation) generates an electric current in the stator 142—this mode of operation is referred to as “generation” and the electric motor 124 used in this way is referred to as generator. In traction motor vehicle applications, the motoring mode provides motion to the vehicle 100. Generation mode takes some of the energy recovered from braking when the vehicle is in the process of stopping and stores it back in the vehicle battery 126.

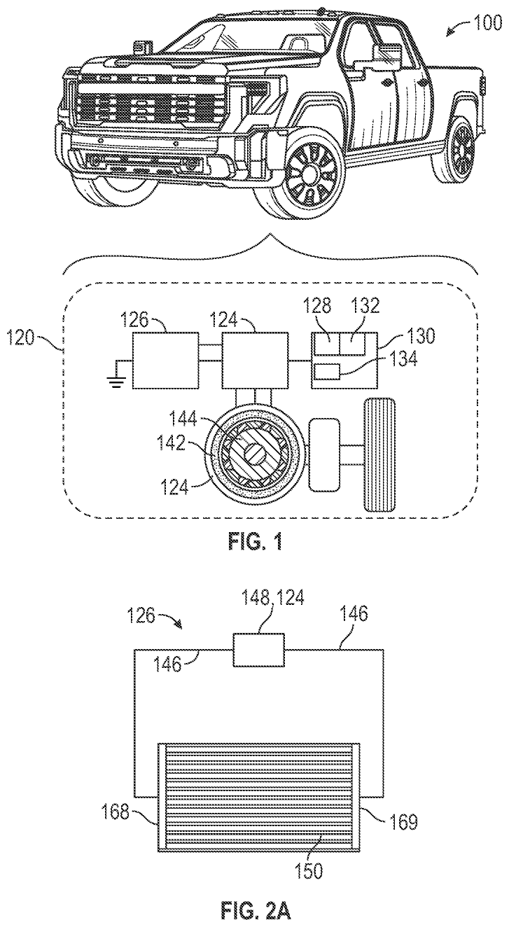

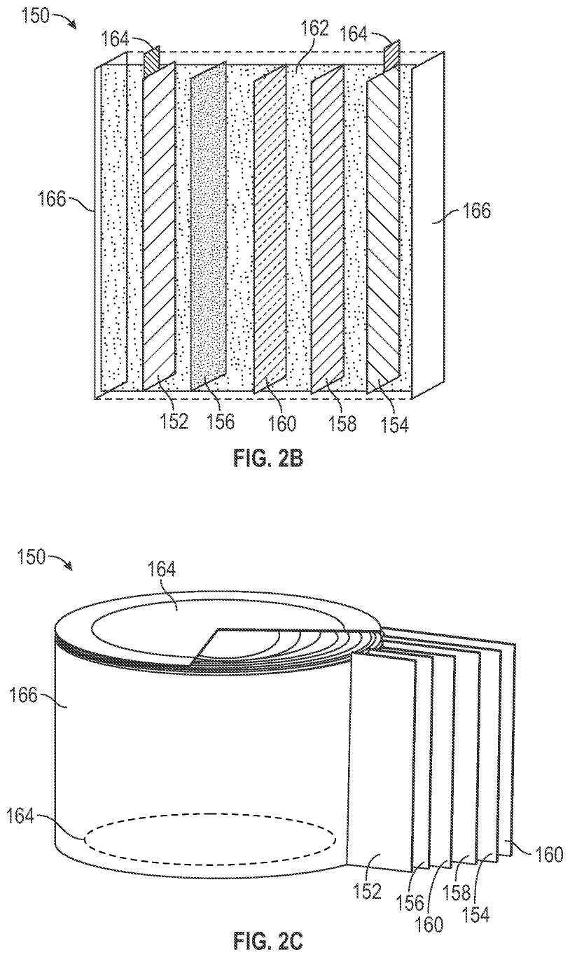

Reference is made to FIGS. 2A, 2B and 2C, which illustrate an example of a secondary battery 126 for powering an electric vehicle 100, such as the electric vehicle 100 illustrated in FIG. 1. As noted above, secondary batteries are understood as rechargeable batteries, that may be discharged upon application of a load and recharged upon the application of an external power source. Referring to FIGS. 2A, 2B, and 2C, the battery 126 is illustrated as being connected to a load 148, such as the electric motor 124. However, other loads 148 include various systems in the vehicle such as climate control systems and infotainment systems. The battery 126 includes one or more battery cells 150, that are assembled together. The battery cells 150 may be, for example, pouch style, prismatic, or cylindrical, discussed further below. During discharge, when as load is applied to the battery 126, Li+ ions move from the anode 158 to the cathode 156 through the separator 160 by way of the electrolyte 162. Equivalent electrons e− move through the circuitry 146 from the cathode 156 to the anode 158, providing voltage to the load 124. While charging, upon application of an external voltage, Li+ ions move from the cathode 156 to the anode 158 by way of the electrolyte 162 through the separator 160 and may be intercalated into the anode 158.

Each battery cell 150, such as those illustrated in FIGS. 2B and 2C, generally includes a cathode current collector 152, a cathode 156 disposed on the cathode current collector 152, an anode current collector 154, an anode 158 disposed on the anode current collector 154, a separator 160 positioned between the cathode 156 and anode 158, and an electrolyte 162. While the illustrated battery cells 150 include one anode 158 (and anode current collector 154) and one cathode (and one cathode current collector 152), the battery cell 150 may alternatively include two or more cathodes 156 (and cathode current collectors 152) and one or more anodes 158 (and anode current collectors 154). In further alternative embodiments, the battery cell 150 may include or one or more cathodes 156 (and cathode current collectors 152) and two or more anodes 158 (and anode current collectors 154). In any of the designs above, one or more separators 160 are interleaved between the cathodes 156 and anodes 158 to prevent the cathodes 156 and the anodes 158 from contacting.

The battery cell 150 of FIG. 2B may be employed in a pouch style battery cell or in a prismatic battery cell. In either design, where multiple cathodes 156 and multiple anodes 158 are present, separators 160 are provided between the cathodes 156 and anodes 158. In embodiments, a ribbon shaped separator 160 may be z-folded around each cathode 156 (and cathode current collector 152) and around each anode 158 (and anode current collector 154). In a pouch style cell, tabs 164 are welded to the cathode current collectors 152 and the anode current collectors 154 and the covering 166 is in the form of a flexible film pouch formed of aluminum or another material. Prismatic style cells, on the other hand, include terminals that the cathode current collectors 152 and anode current collectors 154 are connected to and the covering 166 is formed of a relatively rigid casing, typically in the form of a cuboid. The tabs 164, or terminals, connected to the cathode current collectors 152 from multiple battery cells 150 are connected together, such as by a bus bar 168 or other electrical connection, and the tabs 164, or terminals, connected to the anode current collectors 154 from multiple battery cells 150 are connected together, such as by a bus bar 169 or other electrical connection (see FIG. 2A).

The battery cell 150 of FIG. 2C may be employed in a cylinder style battery cell 150. In this design, the cathode current collector 152, anode current collector 154, cathode 156, anode 158, and one or more separators 160 are in the form of long ribbons, which are rolled into a cylinder or jelly roll. Like the prismatic cell, the cover 166 is formed of a relatively rigid casing of aluminum or another material. Tabs 164 are welded to the cathode current collector 152 and anode current collector 154. The tabs 164 connected to the cathode current collectors 152 from multiple battery cells 150 are connected together, such as by a bus bar 168 or other electrical connection, and the tabs 164, or terminals, connected to the anode current collectors 154 from multiple battery cells 150 are connected together, such as by a bus bar 169 or other electrical connection (see FIG. 2A).

In the various styles of battery cells 150 noted above, the cathode current collector 152 and anode current collector 154 are formed from conductive materials. In embodiments, the cathode current collector 152 may include one or more of aluminum, nickel, and stainless steel; and the anode current collector 154 may include one or more of copper, nickel, stainless steel, and titanium. The current collectors 152, 154 are illustrated as being in the form of a foil; however, it should be appreciated that other forms may be exhibited. The cathode current collector 152 and anode current collector 154 are impermeable to gas. In embodiments, the cathode current collector 152 exhibits a thickness in the range of 5 micrometers to 50 micrometers, including all values and ranges therein, such as in the range of 8 micrometers to 25 micrometers, and the anode current collector 154 exhibits a thickness in the range of 5 micrometers to 50 micrometers, including all values and ranges therein, such as in the range of 5 micrometers to 25 micrometers.

The cathode 156 includes materials that provide a source of lithium ions (Li+) and can undergo reversible insertion or intercalation of lithium ions, determining the capacity and average voltage of a battery. The cathode material includes both a lithium and manganese rich (LMR) composition and a lithium iron phosphate (LFP) composition. The lithium and manganese rich composition exhibits the following formula: xLi₂MnO₃*(1−x)LiMO₂, wherein Li is lithium, Mn is manganese, O is oxygen, x is in the range of 0.1 to 1, including all values and ranges therein, and M is at least one of manganese (Mn), cobalt (Co), and nickel (Ni). In embodiments, the atomic percent of manganese, nickel, and cobalt may exhibit the following relationship in the lithium and manganese rich composition: Mn/(Ni+Co) is greater than 1. In embodiments, nickel is present in the composition and the molar ratio of the manganese to nickel is in the range of 0 to 1.0. In additional or alternative embodiments, the molar ratio of lithium to the transition metals (manganese, cobalt, and nickel) is in the range of 1.05 to 1.60. In further embodiments, the composition is cobalt free and does not include cobalt. In yet further embodiments, the lithium and manganese rich compositions may include one or more of Li₂MnO₃ and LiMnO₂. The iron phosphate composition exhibits the following formula: (LiMn₍ₓ₎FC₍₁₋ₓ₎PO₄), wherein Li is lithium, Mn is manganese, Fe is iron, P is phosphorus, O is oxygen, x is in the range of 0 and 0.95, including all values and ranges therein. In further embodiments, the lithium iron phosphate composition includes LiFePO₄.

The lithium and manganese rich composition is present in a range of 1 weight percent to 99 weight percent of the total weight of the cathode, including all values and ranges therein, and the lithium iron phosphate composition is present in the range of 1 weight percent to 99 weight percent of the total weight of the cathode, including all values and ranges therein. In various embodiments, the lithium and manganese rich composition is present in a range of 50 weight percent to 90 weight percent of the total weight of the cathode, including all values and ranges therein, and the lithium iron phosphate composition is present in the range of 10 weight percent to 50 weight percent of the total weight of the cathode, including all values and ranges therein. In yet further embodiments, the lithium and manganese rich composition is present at 80 weight percent of the total weight of the cathode and the lithium iron phosphate composition is present at 20 weight percent of the total weight of the cathode.

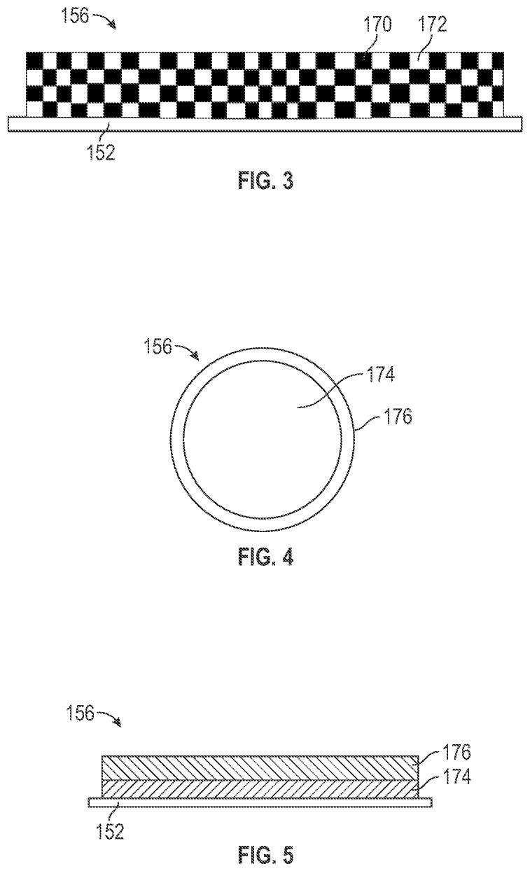

In embodiments, such as illustrated in FIG. 3, the cathode 156 includes a blend of lithium and manganese rich composition domains 170 mixed with lithium iron phosphate composition domains 172, wherein each domain 170, 172 is understood as a distinct volume of either one of the compositions. The lengths (i.e., longest linear dimension) of the lithium and manganese rich composition domains 170 is in the range of 5 micrometers to 15 micrometers, including all values and ranges therein, and the lengths (i.e., longest linear dimension) of the lithium iron phosphate domains 172 is in the range of 1 micrometer to 10 micrometers, including all values and ranges therein. The total cathode thickness is in the range of 50 micrometers to 200 micrometers, including all values and ranges therein. In embodiments, the materials of the cathode 156 are applied to the cathode current collector 152 as a coating using a deposition process, such as a slurry based process, ball milling process, hot roll pressing process, extrusion or additive manufacturing. In embodiments, the cathode compositions may be mixed with a binder and with carbon black filler. The binder may be present in a range of 1 percent to 10 percent of the total weight of the cathode, including all values and ranges therein. The filler may be present in a range of 1 percent to 10 percent of the total weight of the cathode, including all values and ranges therein. The combined cathode 156 and cathode current collector 152 provide a cathode electrode, as referenced further herein. In embodiments, the cathode electrode exhibits a thickness in the range of 100 micrometers to 300 micrometers, including all values and ranges therein.

In additional or alternative embodiments, such as illustrated in FIGS. 4 and 5, the cathode 156 includes one or more layers of the lithium and manganese rich composition 174 and lithium iron phosphate composition 176. With reference to FIG. 4, illustrating the cross-section of an embodiment of a cathode 156, the lithium and manganese rich composition 174 is encased by the lithium iron phosphate composition 176. In FIG. 4, the cathode 156 is in the form of a rod. The lithium and manganese rich composition 174 forms the center of the rod, which is coated with the lithium phosphate composition 176. In this manner, the lithium and manganese rich composition 174 contacts the cathode current collector 152 at either end of the rod (not illustrated) and the lithium iron phosphate composition 176 contacts the electrolyte. The total thickness of the cathode 156 is in the range of 50 micrometers to 200 micrometers, including all values and ranges therein. The lithium and manganese rich composition is 50 percent to 95 percent of the total cathode thickness and the lithium iron phosphate is 5 percent to 50 percent of the total cathode thickness. In embodiments, the materials of the cathode 156 are applied to the cathode current collector 152 and each other as coatings using a deposition process, such as a slurry based process, ball milling process, hot roll pressing process, extrusion or additive manufacturing.

With reference now to FIG. 5, the cathode 156 includes one or more layers of each cathode material deposited on the cathode current collector 152. A first layer of the lithium and manganese rich composition 174 is deposited on a cathode current collector 152 and the lithium and manganese rich composition 174 is coated by a first layer of the lithium iron phosphate composition 176. In this manner, the lithium and manganese rich composition 174 contacts the cathode current collector 152 and the lithium iron phosphate composition 176 contacts the electrolyte 162. In further embodiments, multiple, alternating layers of the lithium and manganese rich composition 174 and lithium iron phosphate composition 176 are applied between the first layer of the lithium and manganese rich composition 174 and the first layer of the lithium iron phosphate composition 176. The total thickness of the cathode 156 is in the range of 50 micrometers to 200 micrometers, including all values and ranges therein. The lithium and manganese rich composition is 50 percent to 95 percent of the total cathode thickness and the lithium iron phosphate is 5 percent to 50 percent of the total cathode thickness. In embodiments, the materials of the cathode 156 are applied to the cathode current collector 152 and each other as coatings using a deposition process, such as a slurry based process, ball milling process, hot roll pressing process, extrusion or additive manufacturing.

The anode 158 includes materials that can undergo reversible insertion or intercalation of lithium ions at a lower electrochemical potential than the cathode 156 material, such that an electrochemical potential difference exists between the anode 158 and cathode 156. The anode material may include one or more of lithium metal; alloys of lithium such as lithium silicon alloy, lithium aluminum alloy, lithium indium alloy, lithium titanate, and lithium tin alloy; carbon based materials such as graphite, activated carbon, carbon black and graphene; silicon; silicon based alloys; silicon oxide; silicon based composite materials; tin oxide; aluminum; indium; zinc; germanium; and titanium oxide; as well as any combination of the above. In embodiments, the anode 158 exhibits a thickness in the range of 50 micrometers to 150 micrometers, including all values and ranges therein. In embodiments, the anode 158 is applied to the anode current collector 154, forming a coating on the anode current collector 154, using a deposition process, such as a slurry based process, hot roll pressing process, extrusion or additive manufacturing. The combined anode 158 and anode current collector 154 provide an anode electrode, as referenced further herein.

The separator 160 is a porous material formed of an electrically insulative material that prevents the cathode 156 and anode 158 from contacting and potentially shortening out the circuit. The separator 160 is sandwiched, or at least partially enclosed, between the cathode 156 and anode 158, allowing the passage of the lithium ions and electrolyte 162 through the pores of the separator 160. The separator 160 may include one or more of a composite, a polymeric material, and a non-woven material. In embodiments, the separator includes at least one of polyethylene, polypropylene, polyamide, polytetrafluoroethylene, polyvinylidene fluoride, and polyvinyl chloride. In addition, the separator 160 may be filled, i.e., include fillers dispersed therein, wherein the filler includes a material such as glass fiber. In additional or alternative embodiments, the separator 160 may include at least one of a thermally stable, porous polymer coating and a ceramic coating such as an alumina coating. The coating is disposed on one or more surfaces of a porous polymer film, the polymer film being selected from at least one of polyethylene and polypropylene. The separator 160 may include one or more layers, wherein each layer is formed from one or more of the materials noted above. The separator 160 may take the form of film or a mesh, such as woven mesh or a slit film. In embodiments, the separator 160 exhibits a thickness in the range of 4 micrometers to 25 micrometers, including all values and ranges therein.

The electrolyte 162 provides a medium between the cathode 156 and anode 158 through which lithium ions and the electrolyte travel. The medium may be a liquid, gel, or solid, and capable of conducting the lithium ions between the cathode 156 and the anode 158. The electrolyte 162 permeates the pores of the porous separator 160 and wets, or otherwise contacts, the surfaces of the cathode 156 and anode 158 as well as the separator 160. In embodiments, the electrolyte 162 includes one or more lithium salts dissolved in non-aqueous organic solvent. The lithium salts may include one or more of the following: lithium hexafluorophosphate (LiPF₆), lithium p perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane) sulfonylimide (LiN(CF₃SO₂)₂), lithium bis(fluorosulfonyl) imide (LiN(FSO₂)₂) (LiSFI), lithium (tricthylene glycol dimethy 1 ether)bis(trifluoromethanesulfonyl)imide (Lia(G3)(TFSI), and lithium bis(trifluoromethanesulfonyl)azanide (LiTFSA). The lithium salt may be present in the electrolyte 162 at a concentration (moles of salt per liter of solvent) ranging from 1 M to 4 M, including all values and ranges therein, such as 2 M or 3 M.

The non-aqueous aprotic organic solvent includes or more of various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxy ethanc), cyclic ethers (e.g., tetrahydrofuran, 2-methyltetrahydrofuran), 1,3-dioxolanc).

Further, the electrolyte 162 may include a number of additives, such as, but not limited to vinyl carbonate, vinyl-ethylene carbonate, propane sulfonate, and combinations therefore. Other additives can include diluents which do not coordinate with lithium ions but can reduce viscosity of the electrolyte 162, such as bis(2,2,2-trifluoroethyl) ether (BTFE), and flame retardants, such as triethyl phosphate.

In embodiments, the battery cells 150 exhibit an operating voltage window in the range of 2.0 Volts to 5.0 Volts, including all values and ranges therein. Further, in embodiments of the above, the battery cells 150 exhibit a C-rate, which is understood as a measure of the rate at which a battery cell is discharged relative to its maximum capacity of C/100 to 6 C. In yet further embodiments of the above, the battery cells 150 exhibit a formation voltage window in the range of 2.0 Volts to 5 Volts including all values and ranges therein. In yet further embodiments of the above, the battery cells 150 exhibit a negative electrode (N) to positive electrode (P) ratio (or anode capacity to cathode capacity) in the range of 1 to 1.3, including all values and ranges therein, wherein N and P are the areal capacities (milliAmp-hours per square centimeter) of the anode and cathode, respectively. More specifically, N is the product of the anode surface density, the active material ratio, and the active material discharge specific capacity and P is the product of the cathode surface density, active material ratio, and active material discharge specific capacity.

The cathode materials described herein are understood to generate a direct current internal resistance relatively less than that of the lithium and manganese rich cathode material alone measured at states of charge between 0 percent to 100 percent total charge, 10 percent to 90 percent total charge, and 20 percent to 80 percent total charge of the battery cell 150. Further, the cathode materials described herein are understood to generate relatively less heat at 101 amp-hours, under 1.6 C rating than that of the lithium and manganese rich cathode material alone measured at states of charge between 0 percent to 100 percent total charge, 10 percent to 90 percent total charge, and 20 percent to 80 percent total charge of the battery cell 150.

### Comparative Example

A battery including a cathode formed from 94 percent by weight of a cathode composition of 80 percent by weight lithium and manganese rich composition (LMR) and 20 percent by weight lithium iron phosphate composition (LFP), 3 percent by weight carbon black and 3 percent by weight of polyvinylidene fluoride, an anode formed from pure graphite, and an electrolyte of 1% lithium difluorophosphate (LiPO₂F₂) in fluoroethylene carbonate (FED):diethyl carbonate (DEC), wherein the volume ratio of FED to DEC is 1 to 4 was compared to a similar battery including a cathode formed from 100 percent by weight lithium and manganese rich composition (LMR). The battery including the cathode composition formed from 80 percent by weight lithium and manganese rich composition and 20 percent by weight lithium iron phosphate composition had a capacity of 4.5 milliAmp-hours per square centimeter and a N/P ratio of 1.2. The battery including the cathode formed from just the lithium and manganese rich composition had a capacity of 4.5 milliamp-hours per square centimeter and a N/P ratio of 1.2.

Resistance (Ohms) of the batteries were measured at a discharge rate of 1 C for a time period of 20 seconds. Specifically, the resistance was tested in the range of 40 to 130 (Ohms) using coin cells, and 0 to 0.5 (Ohms) was tested using pouch cells. The following protocol for hybrid pulse power characterization. Constant current, constant voltage (CCCV) was applied to 4.5 V, C/3 hold to C/20. The battery was allowed to rest for 3 hours and then discharged at C/3 discharge to every 10 percent state of charge (SOC). The battery was allowed to rest for another 3 hours, then the battery was discharged at 1 C discharge pulse for 20 seconds. The battery was allowed to rest for 40 seconds and discharged at 1 C charge pulse for 20 seconds. The battery was allowed to rest for 60 seconds. The discharge steps beginning with discharging at C/3 to every 10 percent state of charge was repeated 9 times.

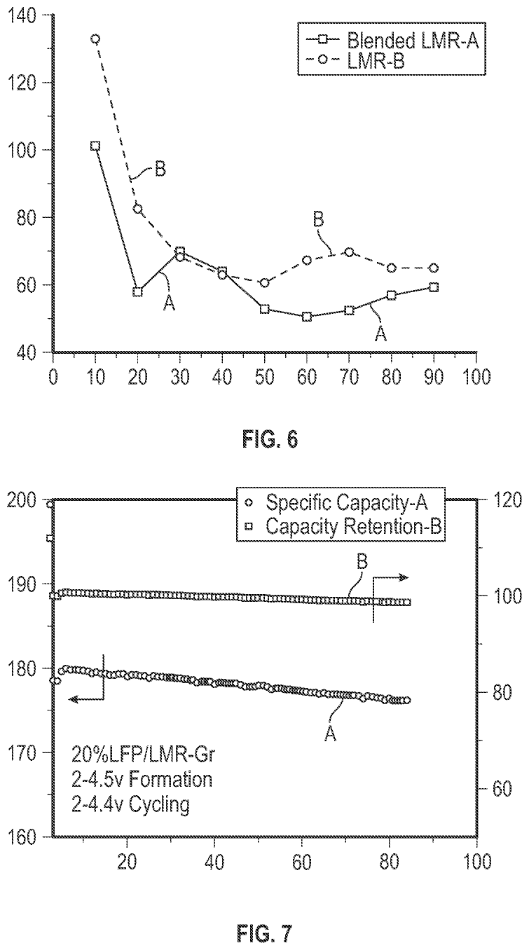

The results are illustrated in FIG. 6. As can be seen the battery including the cathode composition including both the lithium and manganese rich composition and lithium iron phosphate composition generally exhibited lower resistance (line A) at all states of charge compared to the resistance (line B) demonstrated by the battery including the lithium and manganese rich only cathode material, with the exception of between 30 percent and 40 percent state of charge where both batteries performed similarly.

The cycle life performance was measured for the above described battery including the cathode formed from both the lithium and manganese rich composition and the lithium iron phosphate composition. The formation window of the battery was between 2.0 V and 4.5 V at a discharge rate of C/20×2 and a cycling window of 2.0 V and 2.4 V was employed at a cycling rate of C/3 was employed. The results of the measurements are illustrated in FIG. 7. As illustrated, the specific capacity (milliamp-hours per gram) (line A) and capacity retention (percentage) (line B) remained relatively consistent over the course of over 80 cycles.

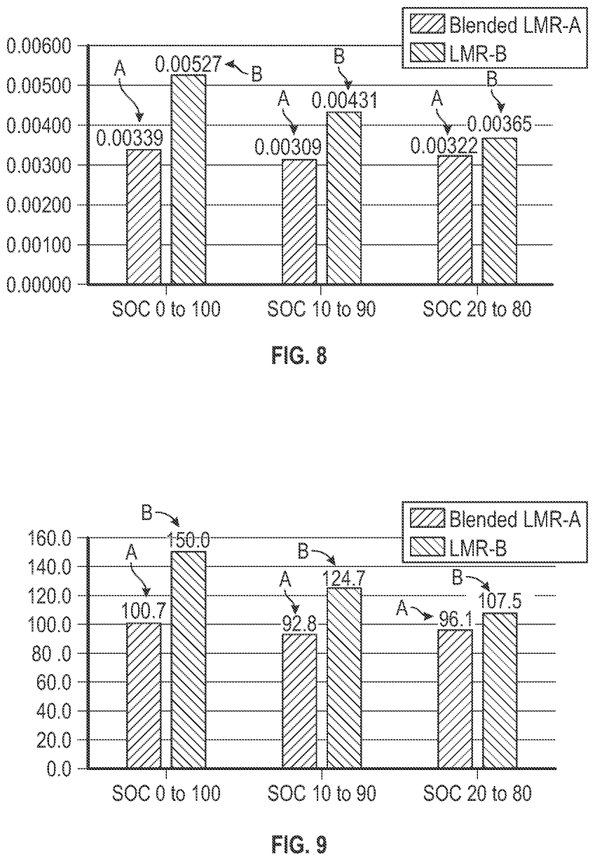

In addition, a direct current internal resistance analysis and a heat generation analysis was performed at varying ranges of states of charge and the results are illustrated in FIGS. 8 and 9, respectively, using the above described batteries. The average direct current internal resistance was measured at state of charge ranges from 0 percent to 100 percent, 10 percent to 90 percent, and 20 percent to 80 percent. The battery cells including the lithium and manganese rich composition and lithium iron phosphate composition in the cathode (bar A) and the lithium and manganese rich only cathode (bar B) were scaled to 101.2 amp-hour, under 1.6 C, and hysteresis was assumed the same (0.0727 volts) as the 5.5 milliamp-hour per square centimeter batteries as illustrated in FIG. 8. The continuous direct current internal resistance of the cathode lithium and manganese rich and lithium iron phosphate compositions (0.0039 Ohm) was reduced to 36% of the lithium and manganese-rich only cathode (0.00527 Ohm) over a range of 0 percent to 100 percent state of charge.

Heat generated, measured in watts (W) was measured for the above described batteries at states of charge in the range of 0 percent to 100 percent, 10 percent to 90 percent, and 20 percent to 80 percent. FIG. 9 illustrates the average heat generated by the cathode including both the lithium and manganese rich composition and lithium iron phosphate composition (bar A) was generally lower at the ranges tested than the heat generated by the lithium and manganese rich only cathode (bar B), particularly where the state of charge ranged from 0 percent to 100 percent where the heat generated was 100.7 Watts compared to 150 Watts. This indicates that significantly less heat was generated between a state of charge between 0 percent to 10 percent where generally higher resistances are typically observed.

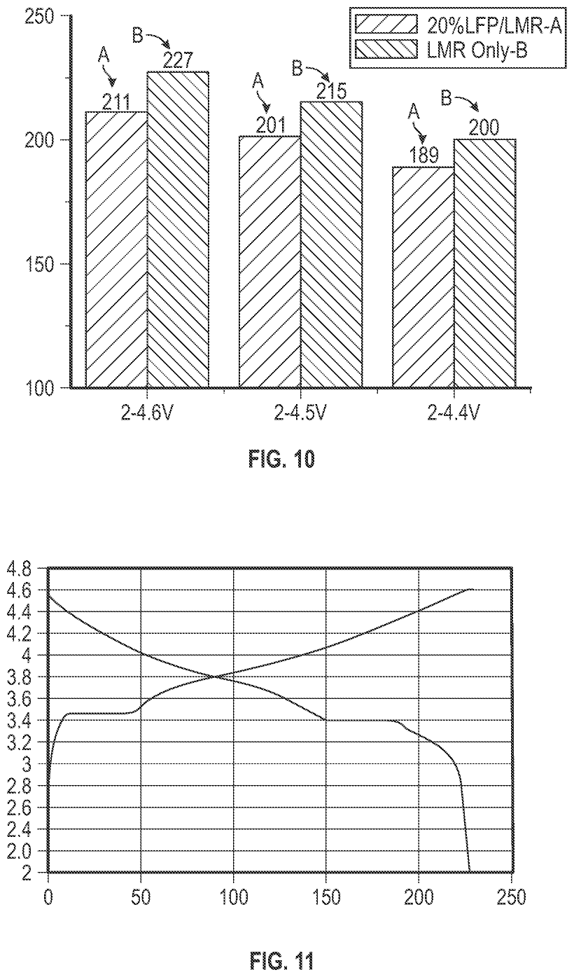

In second comparative example, a battery cell including a cathode formed of 94 percent by weight of a cathode composition including 80 percent by weight lithium and manganese rich composition and 20 percent by weight lithium iron phosphate composition, 3 percent by weight carbon black, and 3 percent by weight polyvinylidene fluoride, a anode of lithium metal, and electrolyte of 1% lithium difluorophosphate (LiPO₂F₂) in fluoroethylene carbonate (FED):diethyl carbonate (DEC), wherein the volume ratio of FED to DEC is 1 to 4 was compared to a similar battery cell including a lithium and manganese-rich only cathode. The porosity of the cathode formed of both the lithium and manganese rich composition and the lithium iron phosphate composition was in the range of 30 percent to 35 percent by volume. The average specific discharge capacity was measured relative to voltage windows of 2 Volts to 4.6 volts, 2 Volts to 4.5 Volts and 2 Volts to 4.4 Volts. FIG. 10 illustrates that the battery cell including the cathode formed from the lithium and manganese rich composition and the lithium iron phosphate composition (bar A) exhibited relatively lower specific discharge capacities, by about 5 percent to 10 percent, than a battery cell with the lithium and manganese rich only cathode (bar B).

Further, FIG. 11 illustrates the half-cell voltage profiles of the battery cell noted with reference to FIG. 10 including the cathode formed the lithium and manganese rich composition and the lithium iron phosphate composition. As illustrated, the voltage profile shows that the lithium iron phosphate composition contributes to the capacity at voltages below 3.5 V and the lithium and manganese rich composition contributes to the capacity at voltages above 3.5 V. Lithium iron phosphate has a lower specific capacity in the range of 140 to 150 milliamp-hours per gram and lower operating voltages of less than 3.5 Volts.

The battery cells and secondary batteries including both the lithium and manganese rich and lithium iron phosphate compositions in the cathode described herein offer a number of advantages. These advantages include, for example, a reduction in the resistance of lithium and manganese rich cathode materials at lower (less than 30 percent) state of charge voltage windows, less than 3.5 Volts. These advantages further include lower heat generation at lower (less than 20 percent) state of charge compared to lithium and manganese rich cathode materials. Further advantages include a reduction in electrolyte oxidative decomposition seen with lithium and manganese rich cathode materials. Further advantages include a relatively higher specific capacity compared to lithium iron phosphate cathode materials, which are typically in the range of 140 to 150 milliampere-hours per gram mass.

As used herein, the term “controller” and related terms such as microcontroller, control module, module, control, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.). The controller 132 may also consist of multiple controllers which are in electrical communication with each other. The controller 132 may be inter-connected with additional systems and/or controllers of the vehicle 100, allowing the controller 132 to access data such as, for example, speed, acceleration, braking, and steering angle of the vehicle 100.

A processor may be a custom made or commercially available processor, a central processing unit (CPU), a graphics processing unit (GPU), an auxiliary processor among several processors associated with the controller 132, a semi composite conductor-based microprocessor (in the form of a microchip or chip set), a macroprocessor, a combination thereof, or generally a device for executing instructions.

The tangible, non-transitory memory 134 may include volatile and nonvolatile storage in read-only memory (ROM), random-access memory (RAM), and keep-alive memory (KAM), for example. KAM is a persistent or non-volatile memory that may be used to store various operating variables while the processor is powered down. The tangible, non-transitory memory 134 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 132 to control various systems of the vehicle 100.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A battery cell for a vehicle, comprising:
a cathode including a lithium and manganese rich composition and a lithium iron phosphate composition;
a cathode current collector connected to the cathode;
an anode;
an anode current collector connected to the anode;
a separator positioned between the anode and cathode; and
an electrolyte contacting the anode and the cathode,
wherein the lithium and manganese rich composition exhibits the following formula: xLi₂MnO₃*(1−x)LiMO₂, wherein x is in the range of 0.1 to 1, M is at least one of manganese, cobalt, and nickel, and the lithium and manganese rich composition is present in a range of 1 weight percent to 99 weight percent of the total weight of the cathode, and wherein the lithium iron phosphate composition exhibits the following formula: (LiMn₍ₓ₎Fe₍₁₋ₓ₎PO₄), wherein x is in the range of 0 and 0.95, and the lithium iron phosphate composition is present in the range of 1 weight percent to 99 weight percent of the total weight of the cathode.

2. The battery cell of claim 1, wherein the lithium and manganese rich composition is present in a range of 75 weight percent to 85 weight percent of the total weight of the cathode and the lithium iron phosphate composition is present in the range of 15 weight percent to 25 weight percent of the total weight of the cathode.

3. The battery cell of claim 1, wherein the cathode includes a first layer of the lithium and manganese rich composition contacts the cathode current collector and a second layer of the lithium iron phosphate composition contacts the electrolyte.

4. The battery cell of claim 3, wherein the total thickness of the cathode is 50 micrometers to 200 micrometers and the thickness of the first layer of the lithium and manganese rich composition is in the range of 50 percent to 95 percent of the total thickness of the cathode and the thickness of the second layer of the lithium iron phosphate composition is in the range of 5 percent to 50 percent of the total thickness of the cathode.

5. The battery cell of claim 3, wherein at least one additional of layer of the lithium and manganese rich composition and at least one additional layer of the lithium iron phosphate composition are alternately layered between the first layer of the lithium and manganese rich composition and the second layer of the lithium iron phosphate composition.

6. The battery cell of claim 1, wherein the cathode includes domains of lithium and manganese rich composition mixed with domains the lithium iron phosphate composition, wherein the domains of the lithium and manganese rich composition exhibits a length in the range of 5 micrometers to 15 micrometers and the domains of the lithium iron phosphate composition exhibit a length in the range of 1 micrometer to 10 micrometers.

7. The battery cell of claim 1, wherein the anode includes at least one or more of the following materials: graphite, silicon, silicon oxide, and lithium metal.

8. The battery cell of claim 1, wherein the electrolyte includes a lithium salt dissolved in a non-aqueous organic solvent.

9. The battery cell of claim 1, wherein a ratio of the anode capacity to cathode capacity (N/P ratio) is in the range of 1 to 1.3.

10. A secondary battery for a vehicle, comprising:
a plurality of battery cells and each battery cell includes:
a cathode including a lithium and manganese rich composition and a lithium iron phosphate composition,
a cathode current collector connected to the cathode, wherein the cathode current collectors of each of the plurality of battery cells are connected together,
an anode,
an anode current collector connected to the anode, wherein the anode current collectors of each of the plurality of battery cells are connected together,
a separator positioned between the anode and the cathode,
and an electrolyte contacting the anode and the cathode,
wherein the lithium and manganese rich composition exhibits the following formula: xLi₂MnO₃*(1−x)LiMO₂, wherein x is in the range of 0.1 to 1, M is at least one of manganese, cobalt, and nickel, and the lithium and manganese rich composition is present in a range of 1 weight percent to 99 weight percent of the total weight of the cathode, and wherein the lithium iron phosphate composition exhibits the following formula: (LiMn₍ₓ₎Fe₍₁₋ₓ₎PO₄), wherein x is in the range of 0 and 0.95, and the lithium iron phosphate composition is present in the range of 1 weight percent to 99 weight percent of the total weight of the cathode.

11. The secondary battery of claim 10, wherein the lithium and manganese rich composition is present in a range of 70 weight percent to 90 weight percent of the total weight of the cathode and the lithium iron phosphate composition is present in the range of 10 weight percent to 30 weight percent of the total weight of the cathode.

12. The secondary battery of claim 10, wherein the cathode includes a first layer of the lithium and manganese rich composition contacts the cathode current collector and a second layer of the lithium iron phosphate composition contacts the electrolyte.

13. The secondary battery of claim 11, wherein the total thickness of the cathode is 50 micrometers to 200 micrometers and the thickness of the first layer of the lithium and manganese rich composition is in the range of 50 percent to 95 percent of the total thickness of the cathode and the thickness of the second layer of the lithium iron phosphate composition is in the range of 5 percent to 50 percent of the total thickness of the cathode.

14. The secondary battery of claim 11, wherein at least one additional of layer of the lithium and manganese rich composition and at least one additional layer of the lithium iron phosphate composition are alternately layered between the first layer of the lithium and manganese rich composition and the second layer of the lithium iron phosphate composition.

15. The secondary battery of claim 10 wherein the cathode includes domains of lithium and manganese rich composition mixed with domains the lithium iron phosphate composition, wherein the domains of the lithium and manganese rich composition exhibits a length in the range of 5 micrometers to 15 micrometers and the domains of the lithium iron phosphate composition exhibit a length in the range of 1 micrometer to 10 micrometers.

16. The secondary battery of claim 10, wherein the anode comprises at least one or more of the following materials: graphite, silicon, silicon oxide, and lithium metal.

17. The secondary battery of claim 10, wherein the electrolyte includes a lithium salt dissolved in a non-aqueous organic solvent.

18. The secondary battery of claim 10, wherein the cathode, the cathode current collector, the anode, the anode current collector, and the separator are in the form of a roll forming a cylinder, the cathode current collector is connected to a first tab and the anode current collector is connected to a second tab.

19. The secondary battery of claim 10, wherein each battery cell further includes a pouch defining a volume, wherein the cathode, the cathode current collector, the anode, the anode current collector, and the separator are positioned at least partially in the volume defined by the pouch.

20. A vehicle, comprising:
a powertrain, the powertrain including a battery, wherein the battery includes a plurality of battery cells and each battery cell includes:
a cathode including a lithium and manganese rich composition and a lithium iron phosphate composition, a cathode current collector connected to the cathode, an anode, an anode current collector connected to the anode, a separator positioned between the anode and the cathode, and an electrolyte contacting the anode and the cathode,
wherein the lithium and manganese rich composition exhibits the following formula: xLi₂MnO₃*(1−x)LiMO₂, wherein x is in the range of 0.1 to 1, M is at least one of manganese, cobalt, and nickel, and the lithium and manganese rich composition is present in a range of 1 weight percent to 99 weight percent of the total weight of the cathode, and wherein the lithium iron phosphate composition exhibits the following formula: (LiMn₍ₓ₎Fe₍₁₋ₓ₎PO₄), wherein x is in the range of 0 and 0.95, and the lithium iron phosphate composition is present in the range of 1 weight percent to 99 weight percent of the total weight of the cathode.
